(19) United States
(12) Patent Application Publication
(10) Pub. No.: US 2021/0103385 A1
(43) Pub. Date: Apr. 8, 2021

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Toru IZUMIYA, Kanagawa (JP)

(73) Assignee: FUJI XEROX CO., LTD., Tokyo (JP)

(21) Appl. No.: 16/836,943

(22) Filed: Apr. 1, 2020

(30) Foreign Application Priority Data
Oct. 2, 2019 (JP) 2019-182175

(51) Int. Cl. G06F 3/0484; G06F 9/451; G06F 16/28

(52) U.S. Cl. CPC G06F 3/04847; G06F 16/284; G06F 9/451

(57) ABSTRACT

An information processing device includes a processor configured to receive a use condition relating to use of a customized user interface from a linkage destination information processing device that is linked to the information processing device in terms of the customized user interface, acquire setting information relating to the customized user interface, the acquired setting information corresponding to the received use condition, execute processing based on the acquired setting information, and return a result of the processing to the linkage destination information processing device.

### CROSS-REFERENCE TO RELATED APPLICATIONS

This application is based on and claims priority under 35 USC 119 from Japanese Patent Application No. 2019-182175 filed Oct. 2, 2019.

### BACKGROUND

### 1. Technical Field

The present disclosure relates to an information processing device and a non-transitory computer readable medium.

### 2. Related Art

JP-A-2008-293152 discloses a linkage method for a Web system including a client terminal in which a Web browser operates, one or more Web systems serving as linkage sources, one or more Web systems serving as linkage destinations, and a WebAPI repository for managing the linkage destinations, which are connected via a network. One or more data types and data values, and a graphical user interface (GUI) for Web system linkage for Web system linkage are embedded as linkage meta. information in contents of a Web system serving as a linkage source. The WebAPI repository manages a name of a linkage destination Web system and one or more data types which are parameters required for calling the linkage destination Web system. A Web system linkage method includes first to fifth steps.

In a first step, the GUI for Web system linkage is activated by a user operation event for Web system linkage on the Web browser, extracts one or more data types from the linkage meta information embedded in the event firing source, and requests the WebAPI repository to search a linkage destination Web system including the extracted data types. In a second step, the WebAPI repository receives a request for search of the linkage destination Web system, extracts one or more data types included in the request, performs search by partial matching with one or more data types which are parameters required for calling the linkage destination Web system managed by the WebAPI repository, and responds to a request source with the search result. In a third step, the GUI for Web system linkage of the request source displays the results of the search by the WebAPI repository in a list form, and receives selection of the linkage destination Web system from a user. In a fourth step, when a parameter for calling the received linkage destination Web system is insufficient by a parameter embedded in the content, the GUI for Web system linkage generates a parameter input reception screen and receives an input of a data value from the user. In a fifth step, the GUI for Web system linkage transmits a request including the embedded data value and a data value if an input of the data value is received to a linkage destination Web system.

### SUMMARY

In a case where a user interface customized in a linkage source information processing device is linked to the linkage destination information processing device, whenever content of customization is changed by the linkage source information processing device, an administrator of the linkage destination information processing device has to customize a user interface of the linkage destination information processing device, which is burdensome.

Aspects of non-limiting embodiments of the present disclosure relate to providing an information processing device and a non-transitory computer readable medium capable of easily linking a user interface customized in a linkage source information processing device to a linkage destination information processing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device includes a processor configured to receive a use condition relating to use of a customized user interface from a linkage destination information processing device that is linked to the information processing device in terms of the customized user interface, acquire setting information relating to the customized user interface, the acquired setting information corresponding to the received use condition, execute processing based on the acquired setting information, and return a result of the processing to the linkage destination information processing device.

### BRIEF DESCRIPTION OF THE DRAWINGS

Exemplary embodiment(s) of the present disclosure will be described in detail based on the following figures, wherein:

FIG. 1 illustrates a configuration of an information processing system according to an exemplary embodiment;

FIG. 2 illustrates a configuration of a linkage source information processing device according to the exemplary embodiment;

FIG. 3 illustrates contents stored in a storage medium according to the exemplary embodiment;

FIG. 4 illustrates an example of contents of an information management database according to the exemplary embodiment;

FIG. 5 illustrates an example of contents of a layout database according to the exemplary embodiment;

FIG. 6 illustrates an example of contents of a setting management database according to the exemplary embodiment;

FIG. 7 is a functional block diagram of the linkage source information processing device according to the exemplary embodiment;

FIG. 8 is a flowchart illustrating an operation of the linkage source information processing device according to the exemplary embodiment;

FIG. 9 is a flowchart of processing of a first specific example;

FIG. 10 illustrates a user interface of a linkage destination information processing device according to the first specific example;

FIG. 11 is a flowchart of processing of a second specific example;

FIG. 12 is a flowchart of processing of a third specific example;

FIG. 13 is a flowchart of processing of a fourth specific example;

FIG. 14 is a flowchart of processing of a fifth specific example;

FIG. 15 is a flowchart of processing of a sixth specific example;

FIG. 16 is a flowchart of processing of a seventh specific example;

FIG. 17 is a flowchart of processing of an eighth specific example;

FIG. 18 is a flowchart of processing of a ninth specific example;

FIG. 19 is a flowchart of processing of a tenth specific example; and

FIG. 20 illustrates hierarchization of document management according to an exemplary embodiment.

### DETAILED DESCRIPTION

### Exemplary Embodiments

Hereinafter, exemplary embodiments of an information processing system including an information processing device according to the present disclosure will be described.

### Configuration of Exemplary Embodiment

FIG. 1 illustrates a configuration of an information processing system JSS according to an exemplary embodiment. Hereinafter, the configuration of the information processing system JSS according to the exemplary embodiment will be described with reference to FIG. 1.

As illustrated in FIG. 1, the information processing system JSS according to the exemplary embodiment includes a linkage source information processing device JS1 and a linkage destination information processing device JS2. The linkage source information processing device JS1 and the linkage destination information processing device JS2 are connected via the Internet and a network (not illustrated) such as an intranet. The “linkage source information processing device JS1” is an example of “information processing device”.

As illustrated in FIG. 1, the linkage source information processing device JS1 and the linkage destination information processing device JS2 share customized user interfaces UI1 and UI2 with each other. In other words, the linkage destination information processing device JS2 links in terms of settings of the customized user interface till of the linkage source information processing device JS1, thereby sharing setting of the customized user interface UI2 with the linkage destination information processing device JS2.

For the above-described link, as illustrated in FIG. 1, the linkage destination information processing device JS2 transmits a request RQ having an identifier SB and a processing name SM to the linkage source information processing device JS1 via the network. The linkage source information processing device JS1 returns a response RP corresponding to the request RQ to the linkage destination information processing device JS2 via the network.

Here, the “request RQ” including the “processing name SM” and the “identifiers SB” is an example of a “use condition relating to use of the customized user interface UI1” in the linkage source information processing device JS1.

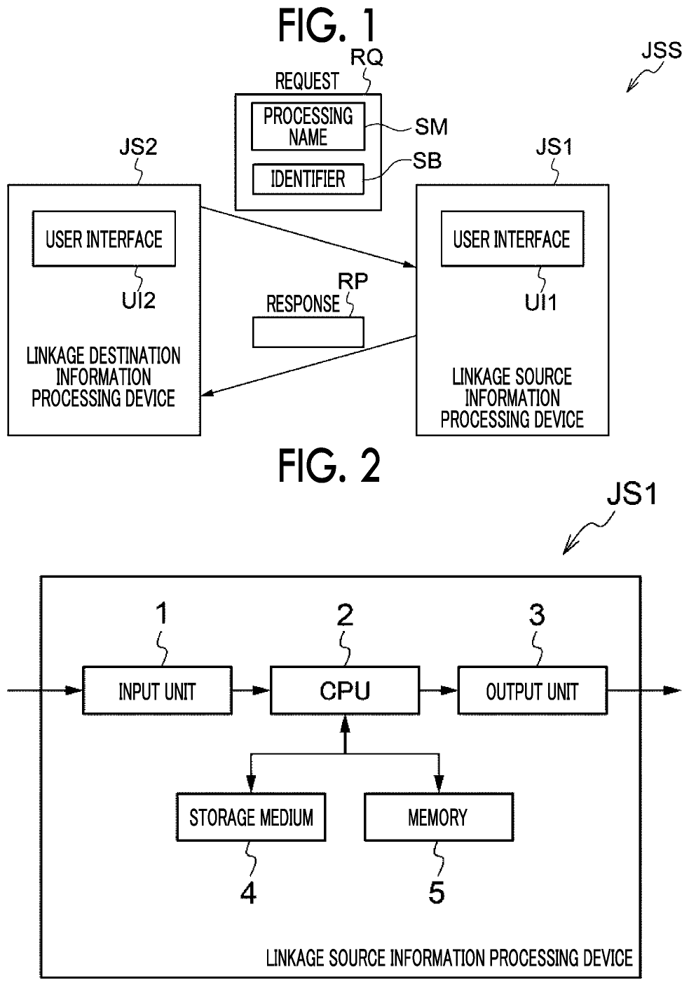

FIG. 2 illustrates a configuration of the linkage source information processing device JS1 according to the exemplary embodiment.

As illustrated in FIG. 2, the linkage source information processing device JS1 according to the exemplary embodiment includes an input unit 1, a central processing unit (CPU) 2, an output unit 3, a storage medium 4, and a memory 5.

The input unit 1 is configured with, for example, a keyboard, a mouse, and a touch panel. The CPU 2 is an example of a processor and is a core of a well-known computer that operates hardware according to software. The output unit 3 is configured with, for example, a liquid crystal monitor. The storage medium 4 is configured with, for example, a hard disk drive (HDD), a solid state drive (SSD), and a read only memory (ROM). The memory 5 is configured with, for example, a dynamic random access memory (DRAM) and a static random access memory (SRAM).

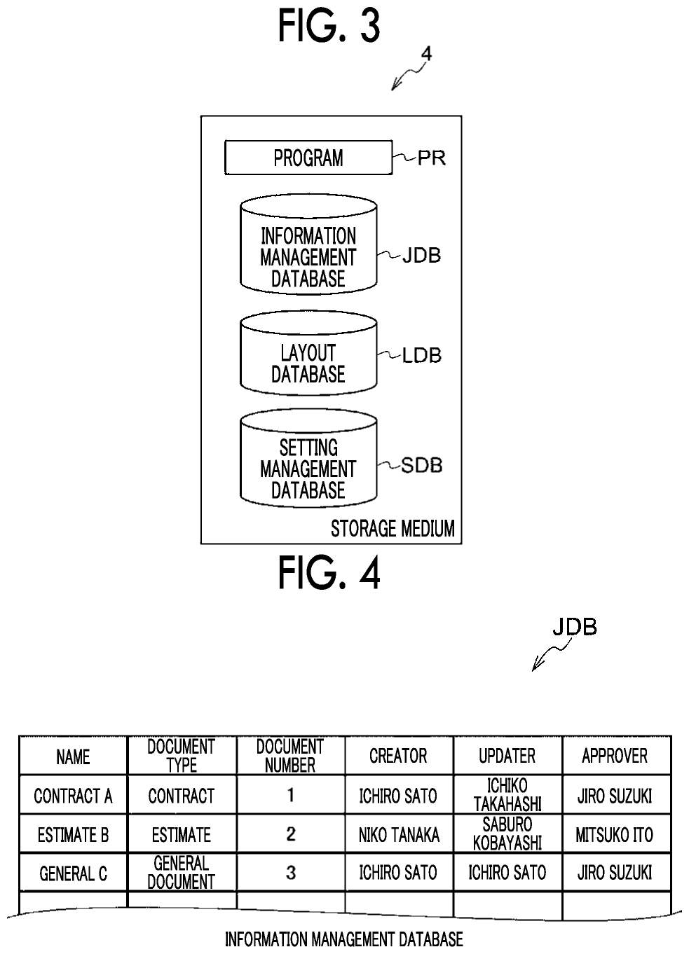

FIG. 3 illustrates contents stored in the storage medium 4 according to the exemplary embodiment.

As illustrated in FIG. 3, the storage medium 4 stores the program PR, the information management database JDB, a layout database LDB, and a setting management database SDB. Here, the “information management database” is an example of the “database”.

The program PR is a command group defining content of processing to be executed by the linkage source information processing device JS1.

FIG. 4 illustrates an example of content of the information management database JDB according to the exemplary embodiment.

The information management database JDB stores documents (not illustrated) such as contracts, estimates, and general documents, and bibliographic items for managing the documents as illustrated in FIG. 4. More specifically, as illustrated in FIG. 4, the information management database JDB stores a name, a document type, a document number, a creator, an updater, and an approver for each document. For example, as illustrated in FIG. 4, the information management database JDB stores a document type “contract”, a document number “1”, a creator “Ichiro Sato”, an updater “Ichiko Takahashi”, and an approver “Jiro Suzuki” for a document having a name “contract A”.

Likewise, as illustrated in FIG. 4, the information management database JDB stores the document type “estimate”, the document number “2”, the creator “Niko Tanaka”, the updater “Saburo Kobayashi”, and the approver “Mitsuko Ito” for a document having a name “estimate B”, and stores the document type “general document”, the document number “3”, the creator “Ichiro Sato”, the updater “Ichiro Sato”, and the approver “Jiro Suzuki” for a document having a name “general C”.

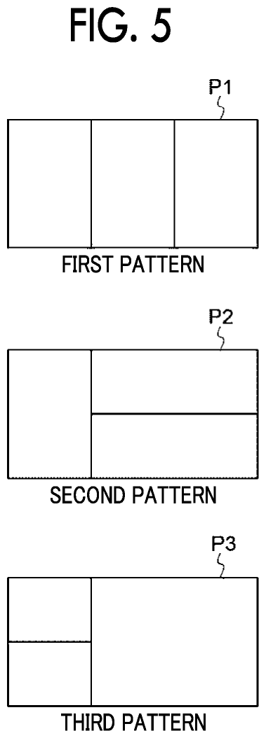

FIG. 5 illustrates an example of the contents of the layout database LDB according to the exemplary embodiment.

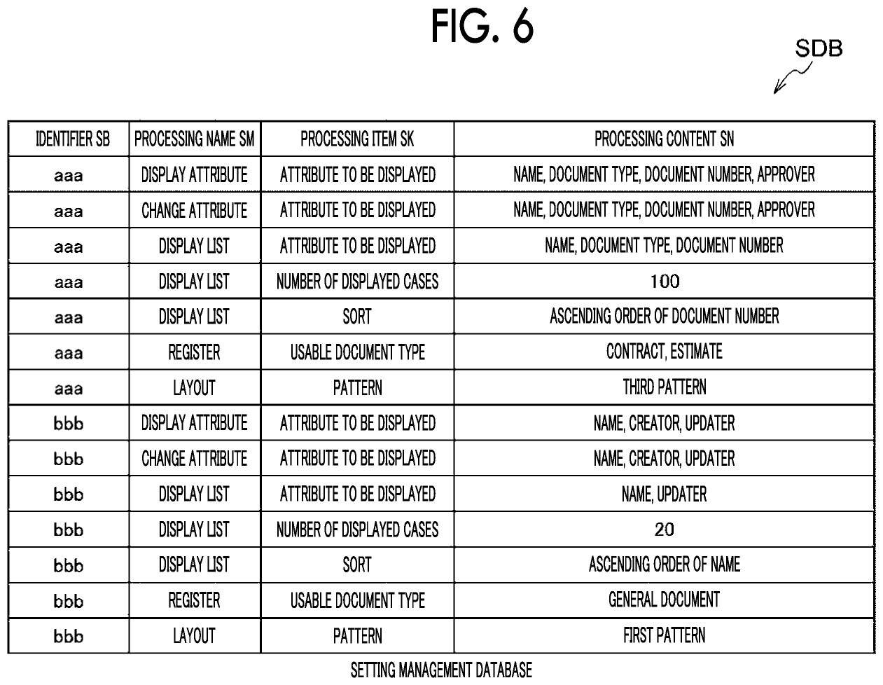

As illustrated in FIG. 5, the layout database LDB stores a first pattern P1, a second pattern P2, and a third pattern P3 as examples of the customized user interface UI1 and UI2 (illustrated in FIG. 1). Each of the first pattern P1, the second pattern P2, and the third pattern P3 has, for example, three fields. The respective fields display, for example, an identifier SB, a processing name SM, and processing content SN (or a result of executing the processing content SN by using the linkage source information processing device JS1) illustrated in FIG. 6 and the like.

FIG. 6 illustrates an example of the content of the setting management database SDB according to the exemplary embodiment.

As illustrated in FIG. 6, the setting management database SDB according to the exemplary embodiment stores the identifier SB, the processing name SM, a processing item SK, and the processing content SN for bibliographic items (illustrated in FIG. 4) relating to documents (contracts, estimates, general documents, and the like) stored in the information management database JDB, and patterns (illustrated in FIG. 5) relating to a layout stored in the layout database JDB. Here, the information management database JDB is an example of “setting information relating to a customized user interface”. The plural processing names SM are common between the plural identifiers SB “aaa” and “bbb”. The plural processing contents SN may differ between the plural identifiers SB “aaa” and “bbb”. For example, the processing name SM “display list” is common between the identifier SB “aaa” and the identifier SB “bbb”. For example, for the processing name SM “display list”, the processing content SN “name, document type, and document number” of the identifier SB “aaa” differs from the processing content SN “name and updater” of the identifier SB “bbb”.

As illustrated in FIG. 6, the setting management database SDB indicates that the processing name SM “display list” can be executed for the processing content SN “name, document type, and document number”, for example, when the identifier SB of a person who intends to access the linkage source information processing device JS1 is “aaa”.

Likewise, as illustrated in FIG. 6, the setting management database SDB indicates that the processing name SM “display list” can be executed for the processing content SN “name and updater” when the identifier SB of the person who intends to access the linkage source information processing device JS1 is “bbb”.

In other words for the two items described above, to a user of the identifier SB “aaa”, the processing name SM “display list” is allowed for the processing content SN “name, document type, and document number”, but the processing name SM “display list” is prohibited for the processing content “updater”. In addition, for a user of the identifier SB “bbb”, the processing name SM “display list” is allowed for the processing content SN “name and updater”, but the processing name SM “display list” is prohibited for the processing content SN “document type and document number”.

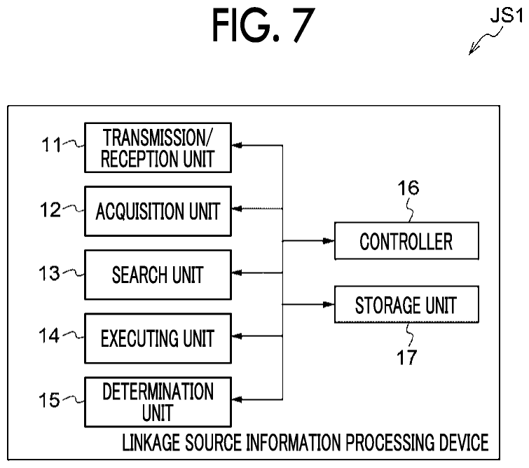

FIG. 7 is a functional block diagram of the linkage source information processing device JS1 according to the exemplary embodiment.

As illustrated in FIG. 7, the linkage source information processing device JS1 includes a transmission/reception unit 11, an acquisition unit 12, a search unit 13, an executing unit 14, a determination unit 15, a controller 16, and a storage unit 17.

Regarding a relationship between the hardware configuration (illustrated in FIG. 2) and the functional configuration (illustrated in FIG. 7) of the linkage source information processing device JS1, on hardware, the CPU 2 executes the program PR stored in the storage medium 4 (implementing a part of a function of the storage unit 17) using the memory 5 (implementing another part of the function of the storage unit 17). If necessary, the CPU 2 controls operations of the input unit 1 and the output unit 3 as the controller 16, so as to implement functions of the transmission/reception unit 11, the acquisition unit 12, the search unit 13, the executing unit 14, and the determination unit 15. The functions of the respective units will be described later.

### Operation of Exemplary Embodiment

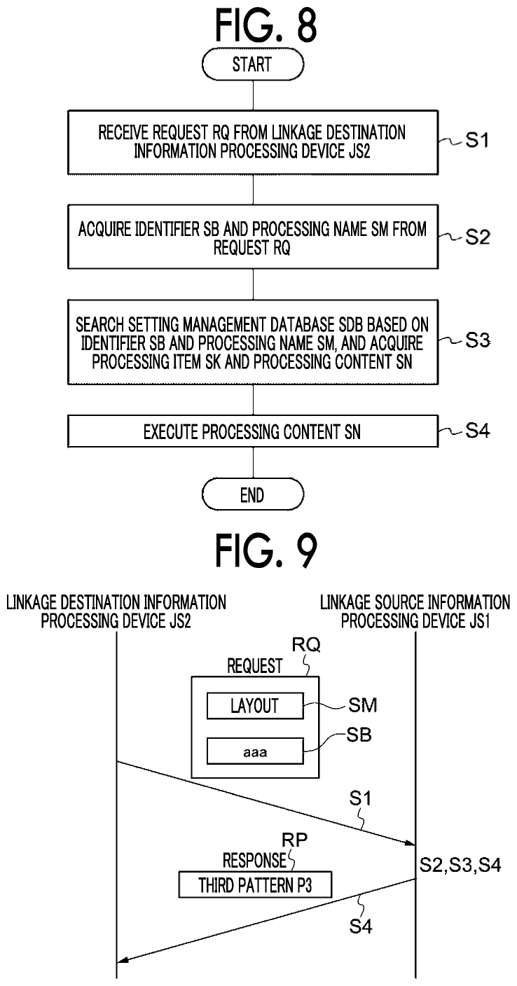

FIG. 8 is a flowchart illustrating an operation of the linkage source information processing device JS1 according to the exemplary embodiment. Hereinafter, the operation of the linkage source information processing device JS1 according to the exemplary embodiment will be described with reference to the flowchart of FIG. 8.

Step S1: a user of the linkage destination information processing device JS2 selects the identifiers SB and the processing name SM from the linkage destination information processing device JS2. As illustrated in FIG. 1, the linkage destination information processing device JS2 transmits the request RQ including the identifiers SB and the processing name SM selected by the user to the linkage source information processing device JS1. In the linkage source information processing device JS1, the CPU 2 (illustrated in FIG. 2) receives the request RQ including the identifiers SB and the processing name SM from the linkage destination information processing device JS2 as the transmission/reception unit 11 (illustrated in FIG. 7).

Step S2: If the request RQ is received in step S1, the CPU 2 acquires the identifier SB and the processing name SM from the received request RQ as the acquisition unit 12 (illustrated in FIG. 7).

Step S3: If the identifier SB and the processing name SM are acquired in step S2, the CPU 2 acquires the processing item SK and the processing content SN corresponding to the identifier SB and the processing name SM as the search unit 13 (illustrated in FIG. 7) by searching the setting management database SDB (illustrated in FIG. 6), based on the acquired identifier SB and processing name SM.

Step S4: If the processing item SK and the processing content SN are acquired in step S3, the CPU 2 executes the processing content SN described above as the executing unit 14 (illustrated in FIG. 7). More specifically, the CPU 2 processes documents (contracts, estimates, general documents, and the like) and bibliographic items relating to the documents stored in the information management database JDB (illustrated in FIG. 4) according to the processing content SN described above as the executing unit 14, thereby, returning the response RP (illustrated in FIG. 1) including the processing result to the linkage destination information processing device JS2.

A function of the linkage source information processing device JS1 (illustrated in FIG. 7) may be executed by a device outside the linkage source information processing device JS1 and the linkage destination information processing device JS2, for example, an external server, instead of being performed inside the linkage source information processing device JS1.

### Specific Example of Operation

Hereinafter, a specific example of the processing of the linkage source information processing device JS1 according to the exemplary embodiment described above will be described.

### First Specific Example: Layout

The processing name SM of a first specific example is “layout” (illustrated in FIG. 6).

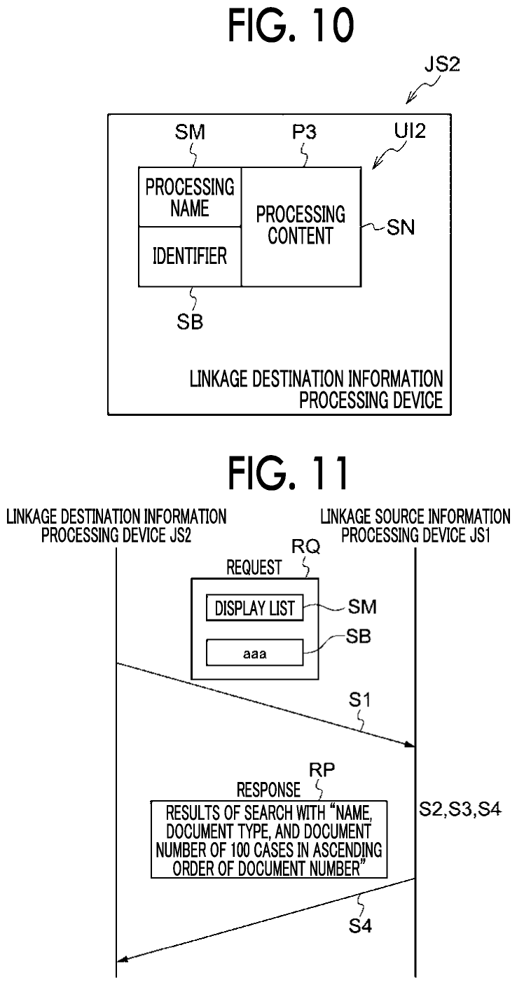

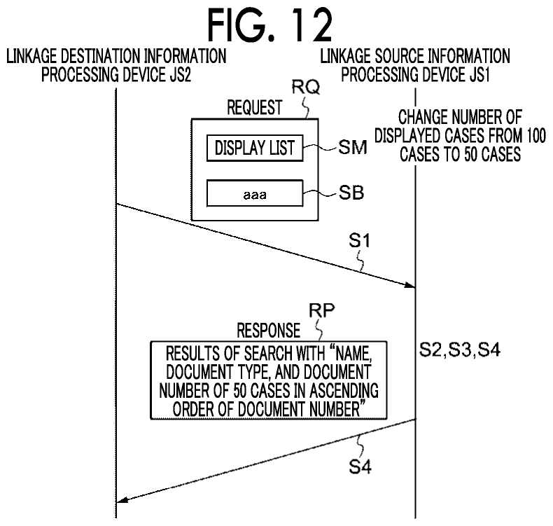

FIG. 9 is a flowchart of processing of the first specific example. Hereinafter, the processing of the first specific example will be described with reference to the flowchart (illustrated in FIG. 8) according to the exemplary embodiment and the flowchart (illustrated in FIG. 9) according to the first specific example.

Step S1: In the linkage source information processing device JS1, the CPU 2 (illustrated in FIG. 2) receives the request RQ from the linkage destination information processing device JS2 as the transmission/reception unit 11.

Step the CPU 2 acquires the identifier SB “aaa” and the processing name SM “layout” from the received request RQ as the acquisition unit 12 (illustrated in FIG. 7).

Step S3: the CPU 2 searches the setting management database SDB (illustrated in FIG. 6) as the search unit 13 (illustrated in FIG. 7) based on the identifier SB “aaa” and the processing name SM “layout” which are acquired, thereby, acquiring the processing item SK “pattern” and the processing content SN “third pattern P3”.

Step S4: the CPU 2 executes the processing content SN “third pattern P3” as the executing unit 14 and the transmission/reception unit 11 (illustrated in FIG. 7), that is, returns the response RP (illustrated in FIG. 1) which is the processing content SN “third pattern P3” to the linkage destination information processing device JS2. Thereby, as illustrated in FIG. 10, the linkage destination information processing device JS2 displays the third pattern P3 (illustrated in FIG. 5) as the customized user interface UI2, and may display the processing name SM, the identifiers SB, and the processing content SN (or a processing result of the processing content SN) in each of three fields of the third pattern P3, respectively.

### Second Specific Example: Display List

The processing name SM of a second specific example is “display list” (illustrated in FIG. 6).

FIG. 11 is a flowchart of processing of the second specific example. Hereinafter, the processing of the second specific example will be described with reference to the flowchart according to the exemplary embodiment (illustrated in FIG. 8) and the flowchart of the second specific example (illustrated in FIG. 11).

Step S1: in the linkage source information processing device JS1, the CPU 2 (illustrated in FIG. 2) receives the request RQ from the linkage destination information processing device JS2 as the transmission/reception unit 11 (illustrated in FIG. 7).

Step S2: the CPU 2 acquires the identifier SB “aaa” and the processing names SM “display list” from the received request RQ as the acquisition unit 12 (illustrated in FIG. 7).

Step S3: the CPU 2 searches the setting management database SDB (illustrated in FIG. 6) as the search unit 13 (illustrated in FIG. 7) based on the identifier SB “aaa” and the processing name SM “display list” which are acquired, thereby, acquiring (i) the processing item SK “attributes to be displayed” and the processing contents SN “name, document type, and document number”, (ii) the processing items SK “sort” and the processing content SN “ascending order of document number”, and (iii) the processing items SK “the number of displayed cases” and the processing content SN “100 cases”.

Step S4: the CPU 2 searches the information management database JDB (illustrated in FIG. 4) as the executing unit 14 and the transmission/reception unit 11 (illustrated in FIG. 7) based on the processing content SN “name, document type, and document number”, “ascending order of document number”, and “100 cases”, and thereafter, returns the response RP (FIG. 1) which is a search result to the linkage destination information processing device JS2. Thereby, the linkage destination information processing device JS2 displays the response RP (illustrated in FIG. 11) which is received from the linkage source information processing device JS1 and is a search result in the processing content SN field (illustrated in FIG. 10) of the customized user interface UI2.

### Third Specific Example: Display List (Change Number of Cases)

The processing name SM of a third specific example is “display list” (change the number of cases) (illustrated in FIG. 6).

FIG. 12 is a flowchart of processing of the third specific example. Hereinafter, the processing of the third specific example will be described with reference to the flowchart according to the exemplary embodiment (illustrated in FIG. 8) and the flowchart of the third specific example (illustrated in FIG. 12).

Hereinafter, as illustrated in FIG. 12, it is assumed that the processing content SN is changed from “100 cases” to “50 cases” for of the processing item SK “the number of displayed cases” of the processing name SM “display list” before the linkage source information processing device JS1 receives the request RQ from the linkage destination information processing device JS2.

Step S1: in the linkage source information processing device JS1, the CPU 2 (illustrated in FIG. 2) receives the request RQ from the linkage destination information processing device JS2 as the transmission/reception unit 11 (illustrated in FIG. 7).

Step S2: the CPU 2 acquires the identifier SB “aaa” and the processing names SM “display list” from the received request RQ as the acquisition unit 12 (illustrated in FIG. 7).

Step S3: the CPU 2 searches the setting management database SDB (illustrated in FIG. 6) as the search unit 13 (illustrated in FIG. 7) based on the identifier SB “aaa” and the processing names SM “display list” which are acquired as described above. Thereby, the CPU 2 acquires the processing item SK “attributes to be displayed” and the processing content SN “name, document type, and document number”, and the processing item SK “sort” and the processing content SN “ascending order of document number” as in the second specific example, and acquires the processing item SK “the number of displayed cases” and the processing content SN “50 cases” unlike the second specific example.

Step S4: the CPU 2 searches the information management database MB (illustrated in FIG. 6) as the executing unit 14 and the transmission/reception unit 11 (illustrated in FIG. 7) based on the processing content SN “name, document type, and document number”, “ascending order of document number”, and “100 cases”, and thereafter, returns the response RP (illustrated in FIG. 1) which is a search result to the linkage destination information processing device JS2. Thereby, the linkage destination information processing device JS2 displays the response RP (FIG. 11), which is the search result and received from the linkage source information processing device JS1, in the processing content SN field (illustrated in FIG. 10) of the customized user interface UI2.

### Fourth Specific Example: Display List (Delete Document Number)

The processing name SM according to a fourth specific example is “display list” (delete document number) (illustrated in FIG. 6).

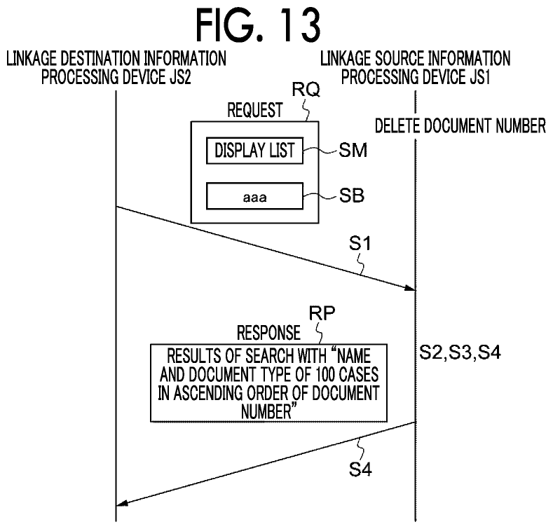

FIG. 13 is a flowchart of processing of the fourth specific example. Hereinafter, the processing content of the fourth specific example will be described with reference to the flowchart according to the exemplary embodiment (illustrated in FIG. 8) and the flowchart according to the fourth specific example (illustrated in FIG. 13).

In the following description, it is assumed that, before receiving the request RQ from the linkage destination information processing device JS2 the linkage source information processing device JS1 deletes the “document number” which is the processing content SN from the processing item SK “attributes to be displayed” of the processing name SM “display list”.

Step S1: in the linkage source information processing device JS1, the CPU 2 (illustrated in FIG. 2) receives the request RQ from the linkage destination information processing device JS2 as the transmission/reception unit 11 (illustrated in FIG. 7).

Step S2: the CPU 2 acquires the identifier SB “aaa” and the processing names SM “display list” from the received request RQ as the acquisition unit 12 (illustrated in FIG. 7).

Step S3: the CPU 2 searches the setting management database SDB (illustrated in FIG. 6) as the search unit 13 (illustrated in FIG. 7) based on the identifiers SB “aaa” and the processing name SM “display list” which are acquired. Thereby, the CPU 2 acquires the “ascending order of document number” and the number of displayed cases “100 cases” as in the second specific example, and acquires the processing content SN “name and document type” unlike the second specific example.

Step S4: the CPU 2 searches the information management database MB (illustrated in FIG. 6) as the executing unit 14 and the transmission/reception unit 11 (illustrated in FIG. 7) based on the processing content SN “name, document type, and document number”, “ascending order of document number”, and “100 cases”, and thereafter, returns the response RP (illustrated in FIG. 1) which is a search result to the linkage destination information processing device JS2. Thereby, the linkage destination information processing device JS2 displays the response RP (illustrated in FIG. 13), which is received from the linkage source information processing device JS1 and is a search result, in the processing content SN field (illustrated in FIG. 10) of the customized user interface UI2.

### Fifth Specific Example: Display List (Change Sort)

The processing name SM of a fifth specific example is “display list” (change sort) (illustrated in FIG. 6).

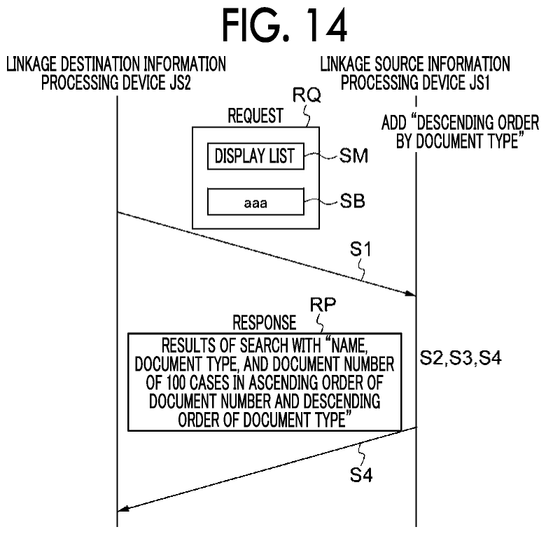

FIG. 14 is a flowchart of processing of the fifth specific example. Hereinafter, the processing of the fifth specific example will be described with reference to the flowchart, according to the exemplary embodiment (illustrated in FIG. 8) and the flowchart of the fifth specific example (illustrated in FIG. 14).

In the following description, it is assumed that the linkage source information processing device JS1 adds “descending order of document type” is the processing content SN to the processing item SK “sort” of the processing name SM “display list” before receiving the request RQ from the linkage destination information processing device JS2.

Step S1: in the linkage source information processing device JS1, the CPU 2 (illustrated in FIG. 2) receives the request RQ from the linkage destination information processing device JS2 as the transmission/reception unit 11 (illustrated in FIG. 7).

Step S2: the CPU 2 acquires the identifier SB “aaa” and the processing name SM “display list” from the received request RQ as the acquisition unit 12 (illustrated in FIG. 7).

Step S3: the CPU 2 searches the setting management database SDB (illustrated in FIG. 6) as the search unit 13 (illustrated in FIG. 7) based on the identifier SB “aaa” and the processing name SM “display list” which are acquired as described above. As a result, the CPU 2 acquires the processing content SN “name, document type, and document number” and “100 cases” similarly to the second specific example, and acquires the processing content SN “in ascending order of document number and in descending order of document type” unlike the second specific example.

Step S4: the CPU 2 searches the information management database JDB (illustrated in FIG. 6) as the executing unit 14 and the transmission/reception unit 11 (illustrated in FIG. 7) based on the processing content SN “name, document type, and document number”, “ascending order of document number and descending order of document type”, and “100 cases”, and thereafter, returns the response RP (illustrated in FIG. 1) which is a search result to the linkage destination information processing device JS2. Thereby, the linkage destination information processing device JS2 displays the response RP (illustrated in FIG. 14), which is received from the linkage source information processing device JS1 and is the search result, in the processing content SN field (illustrated in FIG. 10) of the customized user interface UI2.

### Sixth Specific Example: Display List (Identifier is bbb)

The processing content SN of a sixth specific example is “display list” (identifier SB is bbb) (illustrated in FIG. 6).

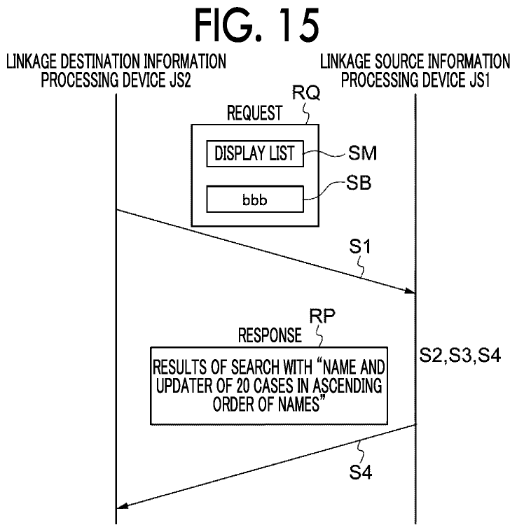

FIG. 15 is a flowchart of processing of the sixth specific example. Hereinafter, the processing of the sixth specific example will be described with reference to the flowchart according to the exemplary embodiment (illustrated in FIG. 8) and the flowchart according to the sixth specific example (illustrated in FIG. 15).

Step S1: in the linkage source information processing device JS1, the CPU 2 (illustrated in FIG. 2) receives the request RQ from the linkage destination information processing device JS2 as the transmission/reception unit 11 (illustrated in FIG. 7).

Step S2: the CPU 2 acquires the processing name SM “display list” from the received request RQ as in the second specific example, and acquires the identifier SB “bbb” unlike the second specific example, as the acquisition unit 12 (illustrated in FIG. 7).

Step S3: the CPU 2 searches the setting management database SDB (illustrated in FIG. 6) as the search unit 13 (illustrated in FIG. 7) based on the identifiers SB “bbb” and the processing name SM “display list” which are acquired as described above. Thereby, unlike the second specific example, the CPU 2 acquires the processing item SK “attributes to be displayed” and the processing content SN “name and updater”, the processing item SK “sort” and the processing content SN “ascending order of name”, and the processing item SK “the number of displayed cases” and the processing content SN “20 cases”.

Step S4: the CPU 2 searches the information management database JDB (illustrated in FIG. 6) as the executing unit 14 and the transmission/reception unit 11 (illustrated in FIG. 7) based on the processing content SN “name and creator”, “ascending order of document number”, and “100 cases”, and thereafter, returns the response RP (illustrated in FIG. 1) which is a search result to the linkage destination information processing device JS2. Thereby, the linkage destination information processing device JS2 displays the response RP (illustrated in FIG. 15), which is received from the linkage source information processing device JS1 and is the search result, in the processing content SN field (illustrated in FIG. 10) of the customized user interface UI2.

### Seventh Specific Example: Change Attribute (Identifier is aaa)

The processing name SM of a seventh specific example is “change attribute” (identifier SB is aaa) (illustrated in FIG. 6).

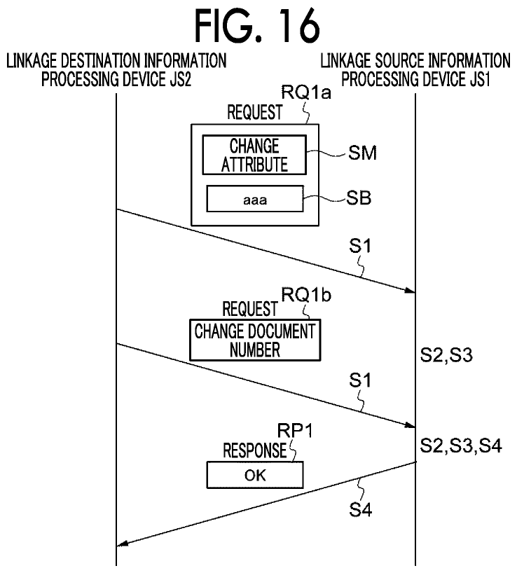

FIG. 16 is a flowchart of processing of the seventh specific example. Hereinafter, the processing of the seventh specific example will be described with reference to the flowchart according to the exemplary embodiment (illustrated in FIG. 8) and the flowchart according to the seventh specific example (illustrated in FIG. 16).

Step S1: in the linkage source information processing device JS1, the CPU 2 (illustrated in FIG. 2) receives a request RQ1a from the linkage destination information processing device JS2 as the transmission/reception unit 11 (illustrated in FIG. 7).

Step S2: the CPU 2 acquires the identifier SB “aaa” and the processing names SM “change attribute” from the received request RQ1a as the acquisition unit 12 (illustrated in FIG. 7).

Step S3: the CPU 2 searches the setting management database SDB (illustrated in FIG. 7) based on the acquired identifier SB “aaa” and the processing name SM “change attribute” as the search unit 13 (illustrated in FIG. 7). Thereby, the CPU 2 acquires the processing content SN “name, document type, document number, and approver”. In the linkage source information processing device JS1, the CPU 2 further receives a request RQ1b “change of document number” from the linkage destination information processing device JS2 as the transmission/reception unit 11. The CPU 2 determines whether or not the received request RQ1b “change of document number” corresponds to the acquired processing content “name, document type, document number, and approver” as the determination unit 15 (illustrated in FIG. 7).

Step S4: After executing the processing corresponding to the request RQ1b “change of document number” (for example, the document number is changed from “1” to “10”) as the executing unit 14 and the transmission/reception unit 11 (illustrated in FIG. 7), the CPU 2 returns a response RP1 “OK” (illustrated in FIG. 16) indicating a result of the processing to the linkage destination information processing device JS2. Thereby, the linkage destination information processing device JS2 displays, for example, an instruction to change the document number from “1” to “10” and the response RP “OK” (illustrated in FIG. 6) received from the linkage source information processing device JS1 in the processing content SN field (illustrated in FIG. 10) of the customized user interface UI2.

### Eighth Specific Example: Change Attribute (Identifier is bbb)

The processing name SM of an eighth specific example is “change attribute” (the identifier SB is bbb) (illustrated in FIG. 6).

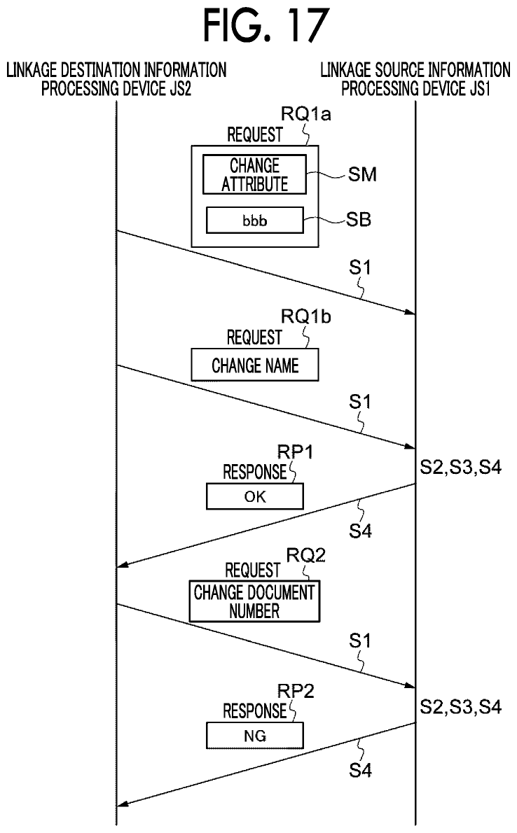

FIG. 17 is a flowchart of the processing of the eighth specific example. Hereinafter, the processing of the eighth specific example will be described with reference to the flowchart according to the exemplary embodiment (illustrated in FIG. 8) and the flowchart according to the eighth specific example (illustrated in FIG. 17).

Step S1: in the linkage source information processing device JS1, the CPU 2 (illustrated in FIG. 2) receives a request RQ1a from the linkage destination information processing device JS2 as the transmission/reception unit 11 (illustrated in FIG. 7).

Step S2: the CPU 2 acquires the identifier SB “bbb” and the processing name SM “change attribute” from the received request RQ1a as the acquisition unit 12 (illustrated in FIG. 7).

Step S3: the CPU 2 searches the setting management database SDB (illustrated in FIG. 6) as the search unit 13 (illustrated in FIG. 7) based on the identifier SB “bbb” and the processing name SM “change attribute” which are acquired as described above. Thereby, the CPU 2 acquires the processing content SN “name, creator, and updater”. As in step S1, in the linkage source information processing device JS1, the CPU 2 further receives the request RQ1b “change of name” from the linkage destination information processing device JS2 as the transmission/reception unit 11 (illustrated in FIG. 7), The CPU 2 determines whether or not the received request RQ1b “change of name” corresponds to the acquired processing content SN “name, creator, and updater” as the determination unit 15 (illustrated in FIG. 7).

Step S4: Since the request RQ1b “change of name” corresponds to the processing content SN “name, creator, and updater”, the CPU 2 executes the processing corresponding to the request RQ1b “change of name” as the executing unit 14 and the transmission/reception unit 11 (illustrated in FIG. 7) (for example, the name is changed from an “estimate B” to an “estimate B1”), and thereafter, returns the response RP1 “OK” indicating a result of the processing to the linkage destination information processing device JS2. Thereby, the linkage destination information processing device JS2 displays, for example, an instruction to change the name from the “estimate B” to the “estimate B1” and the response RP1 “OK” (illustrated in FIG. 17) received from the linkage source information processing device JS1 in the processing content SN field (illustrated in FIG. 10) of the customized user interface UI2.

In contrast to this, in step S1 of step S3, even if the CPU 2 receives the request RQ2 “change of document number” from the linkage destination information processing device JS2 as the transmission/reception unit 11, the CPU 2 determines that the request RQ2 “change of document number” does not correspond to the acquired processing content SN “name, creator, and updater” as the determination unit 15. Therefore, in step S4, the CPU 2 returns the response RP2 “NG” (illustrated in FIG. 17) indicating that the processing is not performed to the linkage destination information processing device JS2 without performing the processing (for example, the name is changed from the “estimate B” to the “estimate B1”) corresponding to the request RQ1b “change of name” as the executing unit 14 and the transmission/reception unit 11. Thereby, the linkage destination information processing device JS2 displays, for example, an instruction to change the name from the “estimate 13” to the “estimate B1” and the response RP2 “NG” (illustrated in FIG. 17) received from the linkage source information processing device JS1 in the processing content SN field (illustrated in FIG. 10) of the customized user interface UI2.

### Ninth Specific Example: Register (Identifier is aaa)

The processing name SM of a ninth specific example is “register” (the identifier SB is aaa) (illustrated in FIG. 6).

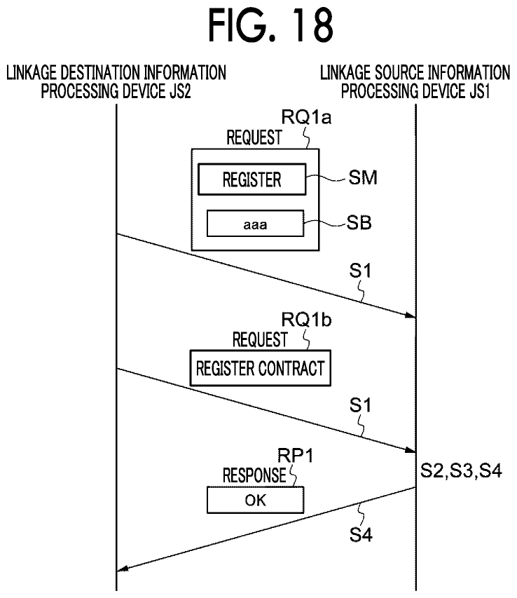

FIG. 18 is a flowchart of the processing of the ninth specific example. Hereinafter, the processing of the ninth specific example will be described with reference to the flowchart according to the exemplary embodiment (illustrated in FIG. 8) and the flowchart according to the ninth specific example (illustrated in FIG. 18).

Step S1: in the linkage source information processing device JS1, the CPU 2 (illustrated in FIG. 2) receives a request RQ1a from the linkage destination information processing device JS2 as the transmission/reception unit 11 (illustrated in FIG. 7).

Step S2: the CPU 2 acquires the identifier SB “aaa” and the processing name SM “register” from the received request RQ1a as the acquisition unit 12 (illustrated in FIG. 7).

Step S3: the CPU 2 searches the setting management database SDB (illustrated in FIG. 6) as the search unit 13 (illustrated in FIG. 7) based on the identifier SB “aaa” and the processing name SM “register” which are acquired. Thereby, the CPU 2 acquires the processing content SN “contract and estimate” for the processing item SK “usable document type” of the processing name SM “register”. As in step S1, in the linkage source information processing device JS1, the CPU 2 further receives the request RQ1b “register contract” from the linkage destination information processing device JS2 as the transmission/reception unit 11. The CPU 2 determines whether or not the received request RQ1b “register contract” corresponds to the acquired processing content “contract and estimate” as the determination unit 15 (illustrated in FIG. 7).

Step S4: After executing the processing corresponding to the request RQ1b “register contract” as the executing unit 14 and the transmission/reception unit 11 (illustrated in FIG. 7) (for example, newly register a “contract D”), the CPU 2 returns the response RP1 “OK” indicating a result of the processing to the linkage destination information processing device JS2. Thereby, the linkage destination information processing device JS2 displays, for example, an instruction to newly register the “contract D” and the response RP1 “OK” (illustrated in FIG. 18) received from the linkage source information processing device JS1 in the processing content SN field (illustrated in FIG. 10) of the customized user interface UI2.

### Tenth Specific Example: Register (Identifier is bbb)

The processing name SM of a tenth specific example is “register” (the identifier SB is bbb) (illustrated in FIG. 6).

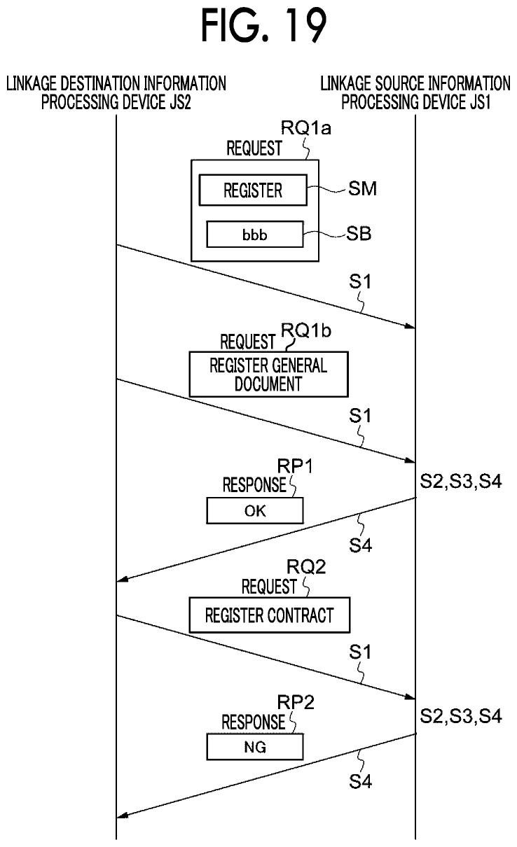

FIG. 19 is a flowchart of processing of the tenth specific example. Hereinafter, the processing of the tenth specific example will be described with reference to the flowchart according to the exemplary embodiment (illustrated in FIG. 8) and the flowchart according to the tenth specific example (illustrated in FIG. 19).

Step S1: in the linkage source information processing device JS1, the CPU 2 (illustrated in FIG. 2.) receives a request RQ1a from the linkage destination information processing device JS2 as the transmission/reception unit 11 (illustrated in FIG. 7).

Step S2: the CPU 2 acquires the identifier SB “bbb” and the processing name SM “register” from the received request RQ1a as the acquisition unit 12 (illustrated in FIG. 7).

Step S3: the CPU 2 searches the setting management database SDB (illustrated in FIG. 6) as the search unit 13 (illustrated in FIG. 7) based on the identifier SB “bbb” and the processing name SM “register” which are acquired as described above. Thereby, the CPU 2 acquires the processing content SN “general document” for the processing item SK “usable document type” of the processing name SM “register” unlike the ninth specific example. As in step S1, in the linkage source information processing device JS1, the CPU 2 further receives the request RQ1b “register general document” from the linkage destination information processing device JS2 as the transmission/reception unit 11. The CPU 2 determines whether or not the received request RQ1b “register general document” corresponds to the acquired processing content SN “general document” as the determination unit 15 (illustrated in FIG. 7).

Step S4: Since the request RQ1b “Register general document” corresponds to the processing content SN “general document”, the CPU 2 executes the processing corresponding to the request RQ1b “register general document” as the executing unit 14 and the transmission/reception unit 11 (illustrated in FIG. 7) (for example, newly register a “general document E”), and thereafter, returns the response RP1 “OK” indicating a result of the processing to the linkage destination information processing device JS2. Thereby, the linkage destination information processing device JS2 displays, for example, an instruction to newly register the “general document E” and the response RP1 “OK” received from the linkage source information processing device JS1 (illustrated in FIG. 19) in the processing content SN field (illustrated in FIG. 10) of the customized user interface U12.

In step S1 of step S3, even if the CPU 2 receives the request RQ2 “register contract” from the linkage destination information processing device JS2 as the transmission/reception unit 11, the determination unit 15 determines that the request RQ1b “register contract” does not correspond to the acquired processing content SN “general document”. Therefore, in step S4, the CPU 2 returns the response RP2 “NG” indicating that the processing is not performed to the linkage destination information processing device JS2 without performing the processing (for example, newly register a “contract F”) corresponding to the request RQ1b “register contract”, as the executing unit 14 and the transmission/reception unit 11. Thereby, the linkage destination information processing device JS2 displays, for example, an instruction to newly register the “contract F” and the response RP2 “NG” (illustrated in FIG. 19) received from the linkage source information processing device JS1 in the processing content SN field (illustrated in FIG. 10) of the customized user interface UI2.

### Hierarchization of Document Management

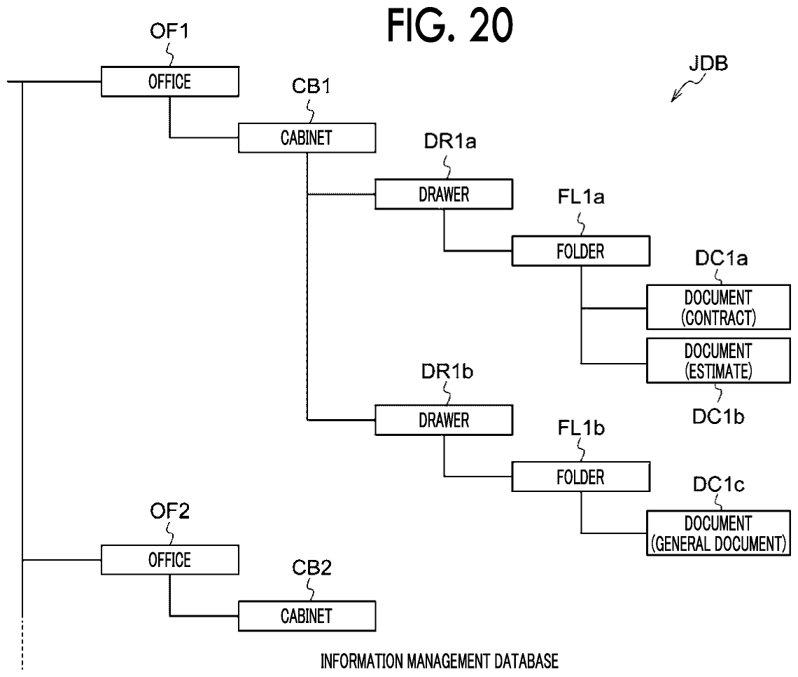

FIG. 20 illustrates hierarchization of the document management according to the exemplary embodiment.

It is desirable that documents (contracts, estimates, general documents, and the like) stored in the information management database JDB are hierarchized by plural objects “office”, “cabinet”, “drawer”, and “folder” and are managed by the information management database JDB (illustrated in FIG. 4) as illustrated in FIG. 20.

Here, the “office” is the highest object in managing documents. The “cabinet” is a second highest object subsequent to the “office” that can be located directly under the “office” and is digitally mimicked from a physical cabinet (document cabinet). The “drawer” is a lower object following the “office” or the “cabinet” that can be located directly under the “cabinet” and is digitally mimicked from a physical drawer. The “folder” is the lowest object following the “office”, the “cabinet”, and the “drawer”, which can be located directly under the “drawer”, and is a receptacle for entry and exit of the documents described above.

When a user of the linkage destination information processing device JS2 attempts to access a document contract, an estimate, a general document, or the like) in the information management database JDB (illustrated in FIG. 20) stored in the storage medium 4 (illustrated in FIG. 2) of the linkage source information processing device JS1, the linkage source information processing device JS1 determines a user's authority to access the information management database JDB based on whether the user identifier SB is “aaa” or “bbb”.

As one example, the CPU 2 of the linkage source information processing device JS1 allows the user to access (register) both a document (contract) DC1a and a document (estimate) DC1b stored in the same folder FL1a when the identifier SB of the user is “aaa” (corresponds to rows of the identifier SB “aaa”, the processing name SM “register”, and the processing content SN “contract and estimate” illustrated in FIG. 7). When the identifier SB of the user is “bbb”, the CPU 2 of the linkage source information processing device JS1 allows to access (register) only the latter document (estimate) DC1b (not illustrated in FIG. 7).

As another example, when the identifier SB of the user is “aaa”, the CPU 2 of the linkage source information processing device JS1 allows to access (register) the document (contract) DC1a and the document (estimate) DC1b stored in the folder FL1a (corresponds to the rows of the identifier SB “aaa”, the processing name SM “register”, and the processing content SN “contract and estimate” illustrated in FIG. 7). When the identifier SB of the user is “bbb”, the CPU 2 of the linkage source information processing device JS1 allows to access (register) the document (general document) DC1c stored in a folder FL1b different from the above-described folder FL1a (corresponds to the rows of the identifier SB “bbb”, the processing name SM “register”, and the processing content SN “general document” illustrated in FIG. 7).

### Supplementary Description of Processor and Program

In the exemplary embodiments described above, a processor indicates a general-purpose processor and includes a dedicated processor (for example, a graphics processing unit (GPU), an application specific integrated circuit (ASIC), a field programmable gate array (FPGA), a programmable logical device, and the like) in addition to a general purpose processor (for example, a central processing unit (CPU) and the like).

In the exemplary embodiments described above, an operation of the processor may be implemented by one processor or by cooperation of multiple processors. A sequence of the operations of the processor is not limited to the sequence in the above-described exemplary embodiments and may be changed as appropriate.

In the exemplary embodiments described above, the program PR may be provided by being recorded in a recording medium such as a compact disc read only memory (CD-ROM), a digital versatile disc read only memory (DVD-ROM), and a Universal Serial Bus (USB) memory instead of being stored (installed) in the storage medium 4 in advance, or the program PR may be downloaded from an external device via a network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to
receive a use condition relating to use of a customized user interface from a linkage destination information processing device that is linked to the information processing device in terms of the customized user interface;
acquire setting information relating to the customized user interface, the acquired setting information corresponding to the received use condition;
execute processing based on the acquired setting information; and
return a result of the processing to the linkage destination information processing device.

2. The information processing device according to claim 1, wherein
the use condition comprises an identifier and processing name for the customized user interface, and
the setting information comprises a processing content for the customized user interface.

3. The information processing device according to claim 1, wherein the processor acquires the setting information from a database indicating a relationship between a plurality of identifiers, and a plurality of processing names and a plurality of processing contents.

4. The information processing device according to claim 2, wherein the processor acquires the setting information from a database indicating a relationship between a plurality of identifiers, and a plurality of processing names and a plurality of processing contents.

5. The information processing device according to claim 3, wherein
the plurality of processing names are common between the plurality of identifiers, and
the plurality of processing contents can be different between the plurality of identifiers.

6. The information processing device according to claim 4, wherein
the plurality of processing names are common between the plurality of identifiers, and
the plurality of processing contents can be different between the plurality of identifiers.

7. The information processing device according to claim 3, wherein the plurality of processing contents are defined according to the plurality of identifiers, so as to be allowed or prohibited for execution of the plurality of processing contents.

8. The information processing device according to claim 4, wherein the plurality of processing contents are defined according to the plurality of identifiers, so as to be allowed or prohibited for execution of the plurality of processing contents.

9. The information processing device according to claim 5, wherein the plurality of processing contents are defined according to the plurality of identifiers, so as to be allowed or prohibited for execution of the plurality of processing contents.

10. The information processing device according to claim 6, wherein the plurality of processing contents are defined according to the plurality of identifiers, so as to be allowed or prohibited for execution of the plurality of processing contents.

11. A non-transitory computer readable medium storing a program causing a computer of an information processing device to execute information processing, the information processing comprising:
receiving a use condition relating to use of a customized user interface from a linkage destination information processing device that is linked to the information processing device in terms of the customized user interface;
acquiring setting information relating to the customized user interface, the acquired setting information corresponding to the received use condition;
executing processing based on the acquired setting information; and
returning a result of the processing to the linkage destination information processing device.

12. An information processing device comprising:
means for
receiving a use condition relating to use of a customized user interface from a linkage destination information processing device that is linked to the information processing device in terms of the customized user interface;
acquiring setting information relating to the customized user interface, the acquired setting information corresponding to the received use condition;
executing processing based on the acquired setting information; and
returning a result of the processing to the linkage destination information processing device.
